(19) United States
(12) Patent Application Publication
(10) Pub. No.: US 2013/0168235 A1
(43) Pub. Date: Jul. 4, 2013

(54) SYSTEM CAPABLE OF AIR CLEANING AND DEHUMIDIFYING

(71) Applicants: Wen-Chang LIN, Kaohsiung City (TW); Sung-Hua Tsai, Kaohsiung City (TW)

(72) Inventors: Wen-Chang LIN, Kaohsiung City (TW); Sung-Hua Tsai, Kaohsiung City (TW)

(73) Assignee: EPOCH ENERGY TECHNOLOGY CORP.

(21) Appl. No.: 13/476,787

(22) Filed: May 21, 2012

(30) Foreign Application Priority Data
Dec. 30, 2011 (TW) 100149832

(51) Int. Cl. C25B 9/00; C25B 15/00; B01D 53/26; C25B 15/02

(52) U.S. Cl. 204/228.2; 204/278; 204/274; 204/276

(57) ABSTRACT

A system is capable of air cleaning and dehumidifying, and includes a condenser device, a water supplying device and an oxyhydrogen ion generating device. The condenser device is operable to form water vapor in ambient air into water droplets. The water supplying device collects the water droplets from the condenser device. The oxyhydrogen ion generating device is coupled to the water supplying device and includes a container receiving water from the water supplying device, electrode plates disposed in the container, and an output conduit. The electrode plates are operable to electrolytically convert water to form oxyhydrogen-ion-containing gas that is released via the output conduit.

### CROSS-REFERENCE TO RELATED APPLICATION

This application claims priority of Taiwanese application no. 100149832, filed on Dec. 30, 2011.

### BACKGROUND OF THE INVENTION

1. Field of the Invention

The present invention relates to a system capable of air cleaning and dehumidifying. 2. Description of the Related Art

Referring to FIG. 1, Taiwanese patent publication no. M404352 discloses a dehumidifier comprising a refrigeration system 1 that includes a compressor 11, a refrigeration coil 12, a collector bucket 13 and a fan 14. When the dehumidifier is activated, the air enters into the dehumidifier through an airway (not shown in the figure). After refrigerant is compressed by the compressor 11, it is transferred through the refrigeration coil 12, and evaporated in the cooling section 121 of the refrigeration coil 12, such that the temperature of air across the refrigeration coil 12 can be lowered and moisture in the air can then be condensed into water droplets, which will then be collected in the collector bucket 13 for discharge. The cooled air will be heated as it flows through the condensing section 122 of the refrigeration coil 12 which releases heat, and finally the heated air having low humidity will then be discharged through operation of the fan 14.

Regular dehumidifiers have the dehumidifying function as described above, wherein the water produced from dehumidifying and collected in the collector bucket 13 must be discharged, causing a waste as they are not reused.

Additionally, in order to improve indoor air quality, a function maintaining air cleanliness to resist germs and reduce foul odor is also in demand. Air purifying technology and associated products in the market have evolved through several stages, from air filtering and absorption that remove pollutant particles in the air to sterilization by ozone and negative ion etc. Although ozone and negative ion techniques are capable of sterilizing and purifying air, ozone is harmful to the human body and thus is not suitable for use in a closed space.

In general, negative ion technique produces ions with negative charge by a negative ion producing circuit, and utilizes positive-negative attraction to cause pollutant particles to attach (deposit) onto positively charged floor and/or wall surfaces. Therefore, after a long period of use, black stains will be formed due to deposits on floor and/or wall surfaces surrounding the negative ion air cleaner, which is a significant drawback.

Current oxyhydrogen ion technology takes electrons away from organic substance (such as germs, viruses or various odor particles) by the high activity of oxyhydrogen ions, and the organic substances that lose electrons will then degrade into smaller molecules such as carbon dioxide and water, due to its loss of bonding capability. Therefore, germs, viruses and odor particles will die or breakdown due to the degradation of organic compounds on their surfaces. Further, oxyhydrogen ion having dangling bonds that can retain moisture in the air aids dry skin and moisturizing, and also can aid in growths of plant and preservation of food.

Therefore, oxyhydrogen ion technology not only can solve the problem of pollutant particles, it is healthy for the human body, and is suitable for use in different types of indoor area, such as home, car, factory, hospitals, etc. How to achieve air cleaning by oxyhydrogen ion and adjusting humidity of an area simultaneously is the subject of this invention.

### SUMMARY OF THE INVENTION

Therefore, an object of the present invention is to provide a system capable of air cleaning and dehumidifying.

According to the present invention, a system is capable of air cleaning and dehumidifying, and comprises:
a condenser device operable to form water vapor in ambient air into water droplets;
a water supplying device for collecting the water droplets from the condenser device; and
an oxyhydrogen ion generating device coupled to the water supplying device and including a container, electrode plates disposed in the container, and an output conduit coupled to the container, the container being disposed to receive water from the water supplying device, the electrode plates being operable to electrolytically convert the water in the container to form oxyhydrogen-ion-containing gas that is released to the environment via the output conduit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional dehumidifier disclosed in Taiwanese Patent Publication No. M404352;

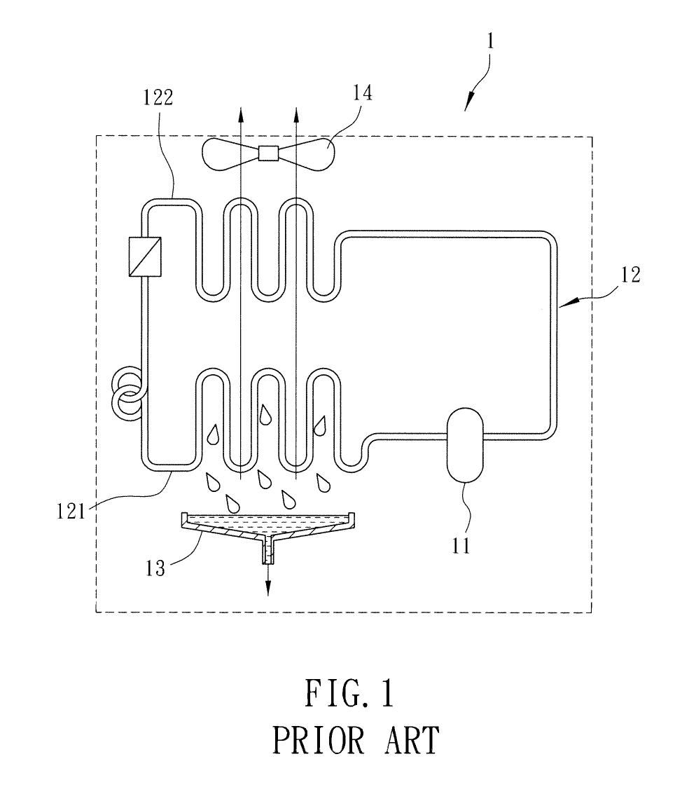

FIG. 2 is a schematic diagram of the first preferred embodiment of a system capable of air cleaning and dehumidifying according to the present invention;

FIG. 3 is a block diagram of the first preferred embodiment;

FIG. 4 is a schematic diagram of the second preferred embodiment of a system capable of air cleaning and dehumidifying according to the present invention; and

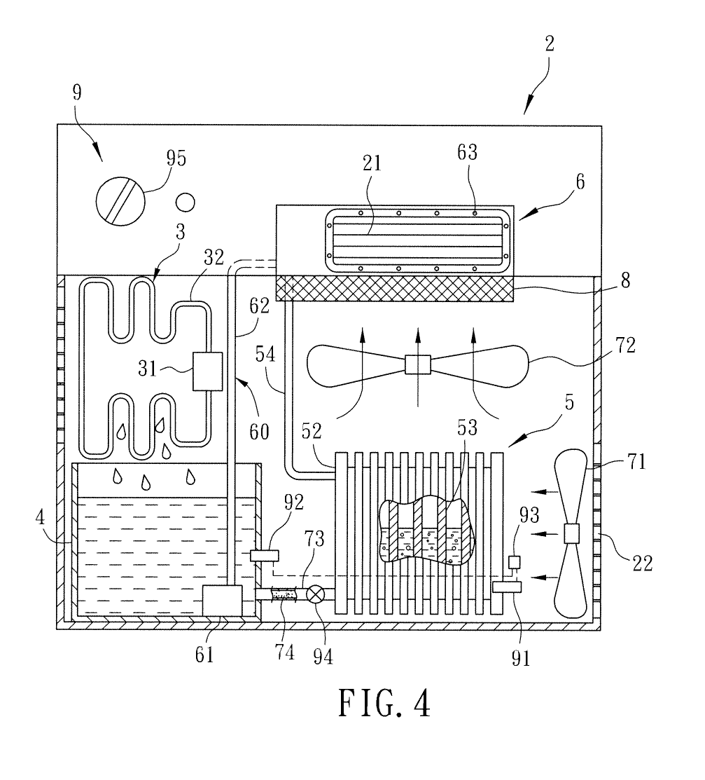

FIG. 5 is a block diagram of the second preferred embodiment.

### DETAILED DESCRIPTION OF THE PREFERRED EMBODIMENTS

Before the present invention is described in greater detail with reference to the preferred embodiments, it should be noted herein that like elements are denoted by the same reference numerals throughout the following description.

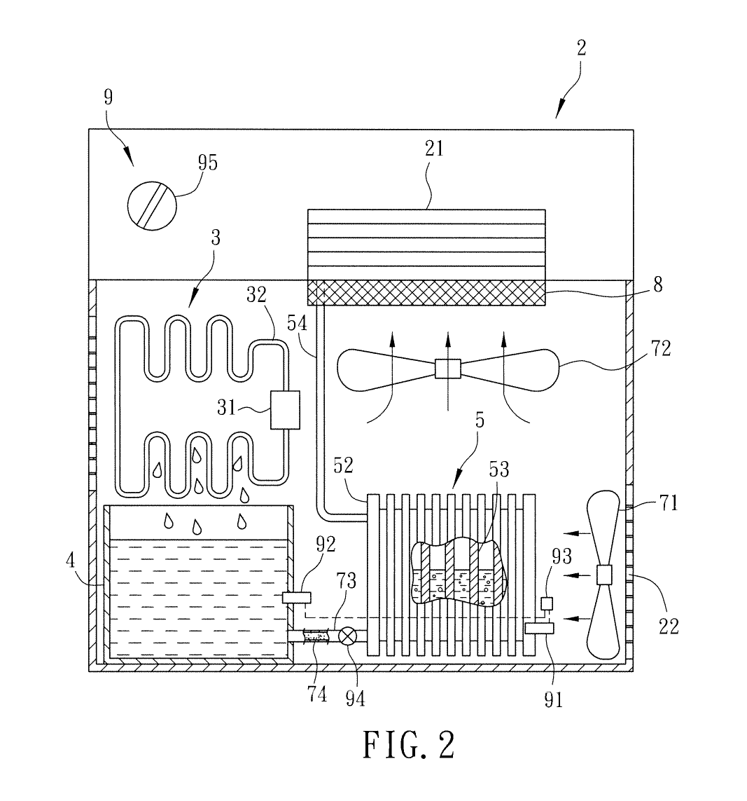

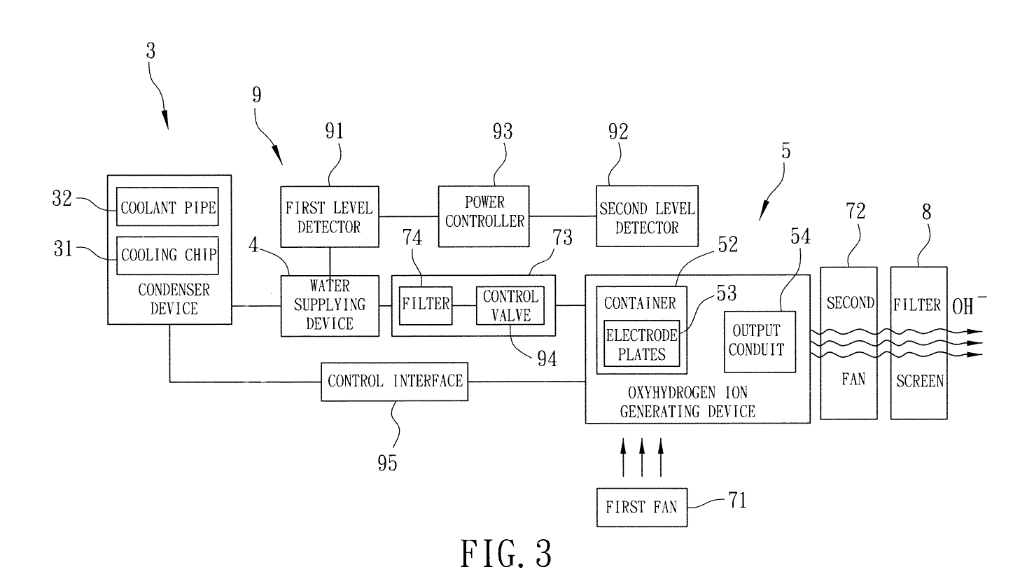

Referring to FIGS. 2 and 3, the first preferred embodiment of a system capable of air cleaning and dehumidifying according to the present invention is shown to comprise a casing 2, a condenser device 3, a water supplying device 4, an oxyhydrogen ion generating device 5, a pipe unit 73, a filter 74, a first fan 71, a second fan 72, a filter screen 8, and a control device 9.

The casing 2 has an air outlet 21 and an air inlet 22.

The condenser device 3 is disposed in the casing 2 and is operable to form water vapor in ambient air into water droplets, thereby achieving a dehumidifying effect.

The water supplying device 4 is disposed in the casing 2 under the condenser device 3 and serves to collect the water droplets from the condenser device 3.

The oxyhydrogen ion generating device 5 is disposed in the casing 2 and includes a container 52, electrode plates 53 disposed in the container 52, and an output conduit 54 coupled to the container 52. The container 52 is disposed to receive water from the water supplying, device 4. The electrode plates 53 are operable to electrolytically convert the water in the container 52 to form oxyhydrogen-ion-containing gas that is released to the environment via the output conduit 54 and the air outlet 21.

The pipe unit 73 interconnects the water supplying device 4 and the container 52 of the oxyhydrogen ion generating device 5.

The filter 74 is disposed in the pipe unit 73 and serves to filter out impurities in the water flowing into the container 52 and thereby avoid accumulation of such impurities in the container 52 that may undesirably affect the efficiency of electrolytic conversion.

The first fan 71 is disposed adjacent to the air inlet 22 for blowing air toward the oxyhydrogen ion generating device 5 to cool the latter.

The second fan 72 is disposed in the casing 2 adjacent to the air outlet 21.

The filter screen 8 is disposed on the casing 2 at the air outlet 21 for filtering the oxyhydrogen-ion-containing gas that is released via the output conduit 54, and prevents contaminants from entering into the output conduit 54 via the air outlet 21.

The system of this embodiment includes the casing 2 such that the system has the form of a single appliance with both air cleaning and dehumidifying functions.

In this embodiment, the condenser device 3 includes a cooling chip 31 operable to reduce temperature of a coolant pipe 32, thereby achieving the effect of condensation. However, the present invention is not limited in this respect. In other embodiments, the condenser device 3 may be one commonly found in conventional dehumidifiers, such as one using a compressor to compress a coolant in a coolant pipe.

The control device 9 includes a first level detector 91, a second level detector 92, a power controller 93 coupled to the first and second level detectors 91, 92, a control valve 94 disposed on the pipe unit 73, and a control interface 95 disposed on the casing 2.

The first level detector 91 is disposed to detect water level in the container 52. When the water level detected by the first level detector 91 corresponds to a low level condition, the control valve 94 is operable to permit flow of water from the water supplying device 4 into the container 52 via the pipe unit 73 so that the water level may be maintained in the container 52.

The second level detector 92 is disposed to detect water level in the water supplying device 4. When the water level detected by the second level detector 92 corresponds to a low level condition, a signal is generated for driving the condenser device 3 to perform condensing so that the water supplying device 4 may have adequate water for use by the oxyhydrogen ion generating device 5.

When the water levels respectively detected by the first level detector 91 and the second level detector 92 both correspond to the low level condition, the power controller 93 is operable to shut down the oxyhydrogen ion generating device 5 and the condenser device 3, thereby preventing overheating and possible damage of the oxyhydrogen ion generating device 5 due to continued operation with insufficient water.

The control interface 95 is coupled electrically to the oxyhydrogen ion generating device 5 and the condenser device 3 and is operable to activate the oxyhydrogen ion generating device 5 and the condenser device 3 independently of each other, Accordingly, the system of this embodiment is operable in a selected one of three modes: a dehumidifying mode where only the condenser device 3 is activated; an air cleaning mode where only the oxyhydrogen ion generating device 5 is activated; and a dehumidifying and air cleaning mode where both the condenser device 3 and the oxyhydrogen ion generating device 5 are activated.

During use, the control interface 95 is manually operated to select the mode of actuation. When the dehumidifying and air cleaning mode is selected, the cooling chip 31 of the condenser device 3 is activated, and condensation of water vapor in air that enters the air inlet 22 occurs to form water droplets on the coolant pipe 32. The water droplets are collected in the water supplying device 4, and the water in the water supplying device 4 flows into the container 52 through the pipe unit 73. The electrode plates 53 operate to perform high voltage electrolysis, producing the oxyhydrogen ions capable of air cleaning. The oxyhydrogen-ion-containing gas thus produced can be released at the air outlet 21 through the output conduit 54. Through the arrangement of the filter screen 8 and the second fan 72, before the oxyhydrogen-ion-containing gas is released, it can be filtered to ensure cleanliness. At the same time, contaminants can be prevented from entering into the output conduit 54 by the filter screen 8.

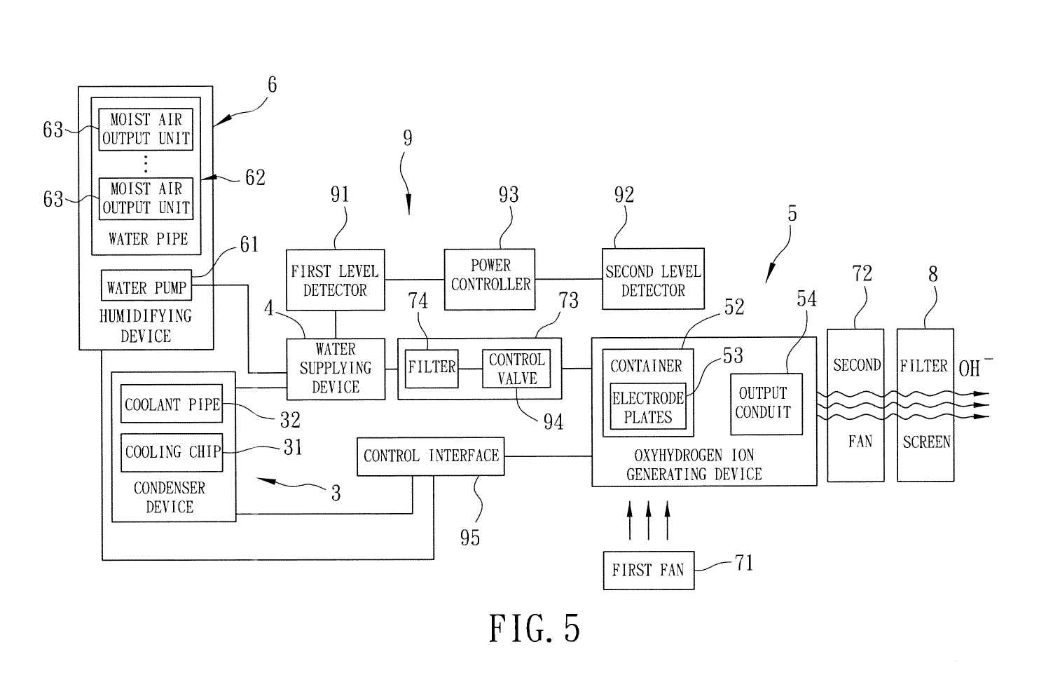

Referring to FIGS. 5 and 6, the second preferred embodiment of the system according to the present invention differs from the previous embodiment in the inclusion of a humidifying device 6 coupled to the water supplying device 4. The humidifying device 6 includes a moist air output unit 63 and a water passage unit 60. In this embodiment, the water passage unit 60 includes a water pipe 62 that is coupled to the moist air output unit 63 and that extends into the water supplying device 4, and a water pump 61 that is disposed at one end of the water pipe 62 for pumping water out of the water supplying device 4. The water drawn by the pump 61 from the water supplying device 4 is transferred to the moist air output unit 63 through the water pipe 62. The moist air output unit 63 is operable to form the water received thereby from the water pipe 62 into moist air using high pressure techniques. The moist air is subsequently released to the environment.

The control interface 95 of the control device 9 is coupled electrically to the humidifying device 6, and the control device 9 can therefore operate to activate the condenser device 3, the oxyhydrogen ion generating device 5 and the humidifying device 6 independently of each other, such that either the condenser device 3 and the oxyhydrogen ion generating device 5 can be activated simultaneously, or the humidifying device 6 and the oxyhydrogen ion generating device 5 can be activated simultaneously.

During use, the control interface 95 is manually operated to select the mode of actuation. When the humidifying and air cleaning mode is selected, the water in the water supplying device 4 can flow into the container 52 through the pipe unit 73, and the electrode plates 53 operate to perform high voltage electrolysis, producing the oxyhydrogen ions capable of air cleaning. Additionally, the pump 61 of the water passage unit 60 will be activated at the same time to draw water from the water supplying device 4, and the water transferred to the moist air output unit 63 through the water pipe 62 will be formed into moist air by the moist air output unit 63 using high pressure techniques. Further, the first fan 71 can guide entry of air into the casing 2 through the air inlet 22 to lower the temperature of the oxyhydrogen ion generating device 5.

The humidifying device 6 provides, an additional function of air humidifying, thereby enabling the user to select an additional mode of operation depending on the humidity of the environment. When humidity is high, both the condenser device 3 and the oxyhydrogen ion generating device 5 can be activated. When humidity is low, both the humidifying device 6 and the oxyhydrogen ion generating device 5 can be activated.

In summary, the system of the present invention, through the integration of the condenser device 3 and the oxyhydrogen ion generating device 5 and the pipe unit 73 between the water supplying device 4 and the oxyhydrogen ion generating device 5, water is transferred to the container 52 for producing oxyhydrogen ions. In this manner, the recycled water from dehumidification can be reused in the production of oxyhydrogen ion that is effective for air cleaning. Furthermore, the humidifying device 6 provides an additional function of humidification for dry environments. As a result, the system of the present invention is able to clean and adjust humidity of air to improve its quality.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A system capable of air cleaning and dehumidifying, comprising:
a condenser device operable to form water vapor in ambient air into water droplets;
a water supplying device for collecting the water droplets from said condenser device; and
an oxyhydrogen ion generating device coupled to said water supplying device and including a container, electrode plates disposed in said container, and an output conduit coupled to said container, said container being disposed to receive water from said water supplying device, said electrode plates being operable to electrolytically convert the water in said container to form oxyhydrogen-ion -containing gas that is released to the environment via said output conduit.

2. The system as claimed in claim 1, further comprising a pipe unit that interconnects said water supplying device and said container of said oxyhydrogen ion generating device, and a control device that includes
a first level detector for detecting water level in said container,
a second level detector for detecting water level in said water supplying device, and
a power controller coupled to said first level detector and said second level detector and operable to shut down said oxyhydrogen ion generating device and said condenser device when water levels respectively detected by said first level detector and said second level detector both correspond to a low level condition.

3. The system as claimed in claim 2, wherein said control device is operable to generate a signal for driving said condenser device to perform condensing when the water level detected by said second level detector corresponds to the low level condition.

4. The system as claimed in claim 1, further comprising a pipe unit that interconnects said water supplying device and said container of said oxyhydrogen ion generating device, and a control device that includes
a first level detector for detecting water level in said container,
a second level detector for detecting water level in said water supplying device, and
a control valve disposed on said pipe unit and operable to permit flow of water from said water supplying device into said container when the water level detected by said first level detector corresponds to a low level condition.

5. The system as claimed in claim 4, wherein said control device is operable to generate a signal for driving said condenser device to perform condensing when the water level detected by said second level detector corresponds to a low level condition.

6. The system as claimed in claim 1, further comprising a control device, said control device including a control interface coupled electrically to said oxyhydrogen ion generating device and said condenser device and operable to activate said oxyhydrogen ion generating device and said condenser device independently of each other.

7. The system as claimed in claim 1, further comprising a fan for cooling said oxyhydrogen ion generating device.

8. The system as claimed in claim 1, further comprising a casing having an air outlet, and a filter screen disposed on said casing at said air outlet, said condenser device, said water supplying device and said oxyhydrogen ion generating device being disposed in said casing.

9. The system as claimed in claim 1, further comprising a humidifying device coupled to said water supplying device and including a moist air output unit and a water passage unit coupled to said moist air output unit, said water passage unit permitting supply of water from said water supplying device to said moist air output unit, said moist air output unit being operable to form the water received thereby into moist air that is released to the environment.

10. The system as claimed in claim 9, wherein said water passage unit of said humidifying device includes a water pipe that extends into said water supplying device, and a water pump disposed at one end of said water pipe for pumping water out of said water supplying device.

11. The system as claimed in claim 9, further comprising a control device, said control device including a control interface coupled electrically to said oxyhydrogen ion generating device, said condenser device and said humidifying device and operable to activate said oxyhydrogen ion generating device, said condenser device and said humidifying device independently of each other.
